(19) United States
(12) Patent Application Publication
(10) Pub. No.: US 2015/0089982 A1
(43) Pub. Date: Apr. 2, 2015

(54) ELECTRONIC LOCK

(71) Applicant: TRI STAR INC., Tongzhou City (CN)

(72) Inventors: Xi'an CHEN, Shanghai (CN); Jiayan LIU, JiangSu Province (CN); Wenkun CHEN, Shanghai (CN)

(73) Assignee: TRI STAR INC., Tongzhou City (CN)

(21) Appl. No.: 14/162,097

(22) Filed: Jan. 23, 2014

(30) Foreign Application Priority Data
Sep. 30, 2013 (CN) 201310461363.0

(51) Int. Cl. E05B 47/00; E05C 3/16

(52) U.S. Cl. CPC E05B 47/0001; E05B 47/0012; E05C 3/16
USPC 70/278.7

(57) ABSTRACT

This invention discloses an electronic lock, including cam lock assembly, electronic control assembly, lock latch assembly and latch bolt assembly. The latch bolt assembly includes latch bolt, latch bolt bracket and latch shaft. The latch bolt mentioned is pivoted at the latch bolt bracket, while latch shaft is translational positioned at it. By the latch shaft, cam bolt and electronic control assembly can connect with latch bolt and latch component in sequence. The latch shaft is configured with reset and compression spring, while latch bolt is with torsion spring and latch mounting parts, then the latch is able to linkage connect through latch mounting parts. From stated above, we can know the invention is ingeniously designed to lock/unlock latch parts, having lock assembly and electronic control assembly sharing one set of lock bolt (latch bolt). It can be seen that the invention effectively simplifies the existing lock structure.

### APPLICATION OF THE INVENTION

In a first aspect of the present invention, the inventive electronic lock is intended to be mounted within the enclosure of a safe, a draw of a furniture and an office equipment such as, for example, a safe designed to store firearms, cash and passports. The inventive latch is a latch of general utility and may be used in any desired environment.

### BACKGROUND OF THE INVENTION

The traditional electronic lock has a complex structure without high reliability.

### SUMMARY OF THE INVENTION

The present invention relates to an electronic lock which has a relook structure, for the above shortcomings. The present invention can effectively improve the reliability of the lock. Furthermore, the present invention simplifies the structure of the lock as well.

The present invention includes the following interrelated objects, aspects and features:

The inventive electronic lock includes lock assembly, electronic control assembly, lock latch assembly and latch bolt assembly. The said latch bolt assembly includes a pivotable latch bolt, latch bolt bracket and latch shaft, the said latch bolt is pivoted at the latch support, and the said latch shaft is translational positioned at it. By the latch shaft, cam bolt and electronic control assembly can connect with latch bolt and latch component in sequence. The said latch shaft is mounted a reset and compression spring, the said latch bolt is mounted a torsion spring and a latch mounting housing, then the said latch bolt is connected lock latch assembly via said latch mounting housing.

Further, in this invention, said latch bolt bracket includes two support sheets designed and arranged in parallel, namely the first support sheet, the second support sheet. Said support sheets are connected by fasteners. In addition, a latch bolt mounting post (screw bolt) is designed to support the latch bolt mounted between the said two support sheets. The said torsion spring is mounted around said latch bolt mounting post.

Further, in this invention, said latch shaft is a stepped shaft, including the cam bolt mounting portion, the latch bolt locking portion and spring mounting portion. The diameter of said latch bolt locking portion is bigger than the one of the spring mounting portion. The said cam bolt mounting portion is connected to the cam bolt via a soft string. The end of the spring mounting portion is withstood by the power output inclined plane or spiral surface of said lock electronic control assembly. Said spring mounting portion is designed through the first support sheet. Said latch bolt locking portion is on the left of the second support sheet. A spring collar is mounted nearly to the end of the spring mounting portion. The two ends of said compression spring is mounted between said first support sheet and said spring collar.

Further, in this invention, said latch bolt is a disk. The mounting hole is designed on the center of the latch bolt. Said latch bolt is mounted on said latch bolt housing via said mounting hole. Meanwhile, said latch bolt includes two transmission portions. One is inclined plane connected said latch shaft by the means of unlocking and locking, another is a block bar mounting portion which is slot and linkage connect to a block bar assembly. In addition, a torsion spring mounting post is designed on the plate of said latch bolt, and which is fastened with an end of the torsion spring.

Further, in this invention, said block bar assembly includes U-shaped block bar. Said U-shaped block bar is a U-shaped rod element, including one horizontal portion and two vertical legs in the same direction. Said horizontal portion is fixed with said slot of said latch bolt.

Further, in this invention, said electronic control assembly includes a motor housing, a drive electric motor which is mounted on said mounting housing and a drive disk which is mounted on an output terminal of said drive motor. Said drive disk is designed to bean inclined cam disk, or a helicoidal cam disk. An inclined plane of said drive disk or a helicoidal surface of said helicoidal cam disk is withstood by said latch shaft. A limiting mechanism is designed between inclined cam disk (or said helicoidal cam disk) and said motor housing.

Further, in this invention, said limiting mechanism includes a dowel pin and a limiting block leg. Said spring pin is mounted on said inclined cam disk. Said limiting block leg is a shoulder on the electric motor housing.

Further, in this invention, said electric motor housing includes two portions of bending edges designed and arranged in parallel, which includes two U-shaped slots. Said electric motor is fixed and hanged by said U-shaped slots.

Further, in this invention, said cam lock assembly, said electric control assembly, said latch assembly and said latch bolt assembly are all mounted and concealed inside a whole housing assembly. Said whole housing assembly includes a lock mounting housing and a lock plate connected to the lock mounting housing.

Further, in this invention, said whole housing assembly includes an electrical mounting assembly and a mechanical mounting assembly. A PCB module of said electronic control assembly is mounted in said electrical mounting assembly. Said electric motor, said drive disk and said cam lock assembly, said latch bolt assembly and said latch bolt assembly are mounted in the mechanical mounting assembly. Said electrical mounting assembly and said mechanical mounting assembly may be connected together via screws and nuts.

As per the above technical solutions, this invention own the following beneficial effects compared with the existing technology:

In said inventive electronic lock, said cam lock assembly and said electric control assembly are designed to connect the common the lock cylinder (said latch bolt assembly), which actuate said latch shaft to unlock or lock said block bar assembly, therein, said connection between said latch bolt assembly and said cam lock assembly is designed to unlock at the emergency of a low battery or a password-forgetting. Accordingly, this invention simplifies effectively the structure of existing locks.

Said latch shaft herein achieves the translational motion through the orientation of said reset and compression spring, the latch bolt bracket, thus, achieving the locking between said latch shaft and said latch bolt. Said latch bolt achieves the rotational motion through said torsion spring, thus removing the force of the latch assembly from the latch bolt through by overcoming the deformation of the torsion spring. The latch bolt coverts its rotational motion through the latch mounting portion to the translational motion of the latch assembly. Therefore, the latch shaft and its mounting assembly, reset spring, spring collar form the like a relock device, effectively ensures the reliability of said electronic lock.

Said electronic device herein can control the translational motion of said latch shaft via Said drive disk which is designed to be an inclined disk and said latch bolt housing which directs said latch shaft.

Said latch bolt herein can push out said U-shaped block bar through said slot of said latch bolt.

### BRIEF DESCRIPTION OF THE DRAWINGS

FIG. 1 shows a perspective view of the inventive electronic lock with the latch bolt thereof in a closure position.

FIG. 2 shows a perspective view of the inventive electronic lock which removed the lock plate and U-shaped bracket.

FIG. 3 shows an explored view similar to that of FIG. 1.

FIG. 4 shows atop view of the inventive electronic lock.

FIG. 5 shows a cross-sectional view along the line A-A of FIG. 4.

FIG. 6 shows a cross-sectional view along the line B-B of FIG. 4.

FIG. 7 shows a cross-sectional view along the line C-C of FIG. 6.

FIG. 8 shows a cross-sectional view along the line D-D of FIG. 7.

FIG. 9 shows a rotate-sectional view along the broken line E-E of FIG. 8.

FIG. 10 shows a detail view inside the circle I of FIG. 6.

FIG. 11 shows a detail view inside the circle II of FIG. 5.

FIG. 12 shows a front view of the present invention.

FIG. 13 shows a perspective view of the helicoidal disk of the inventive drive disk.

### SPECIFIC DESCRIPTION OF THE PREFERRED EMBODIMENT

Figures non-restrictively disclose the technical means of the invention. The following will describe the invention technical solutions with the figures.

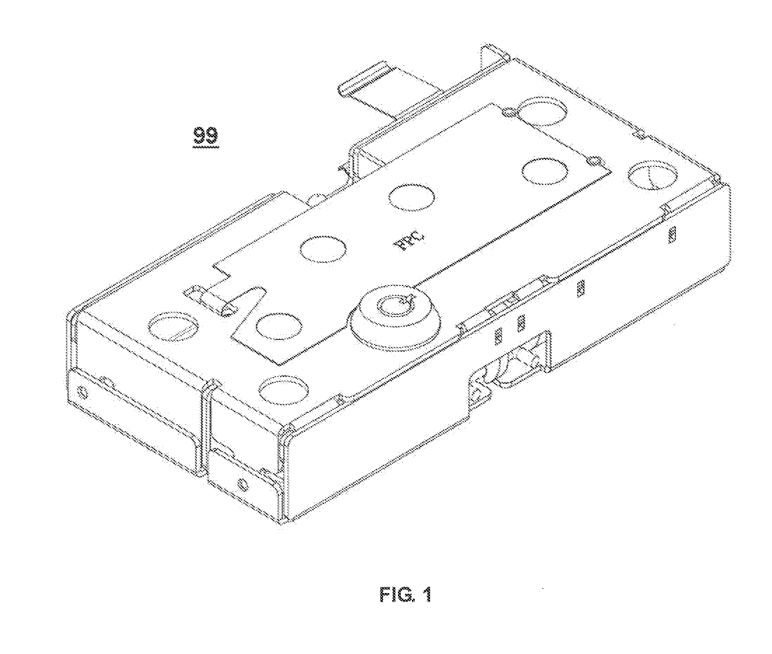

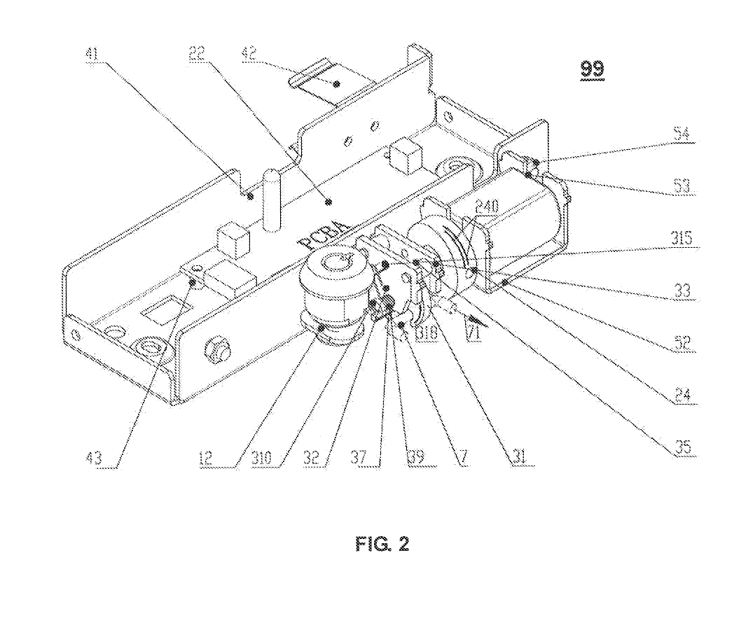

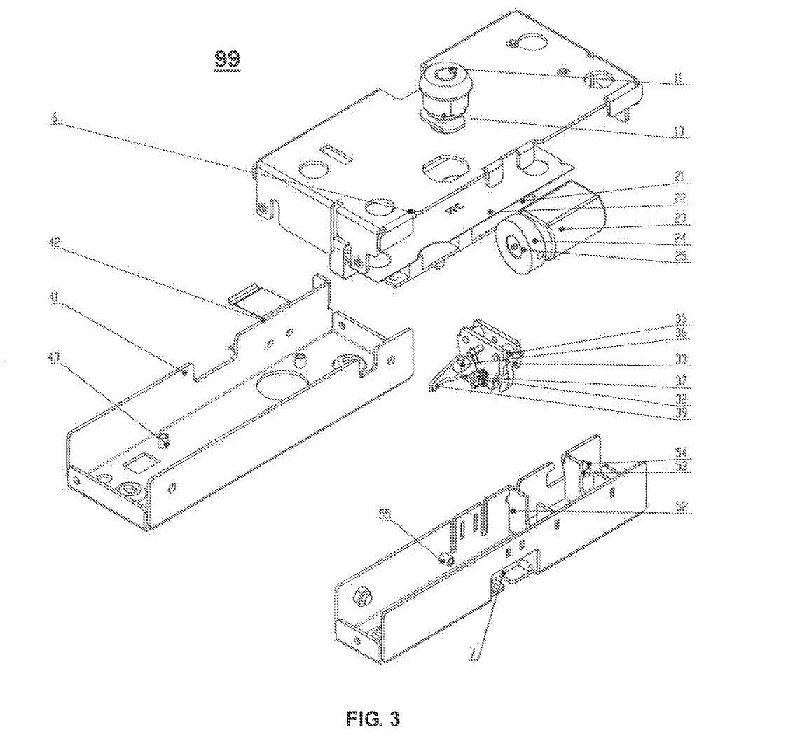

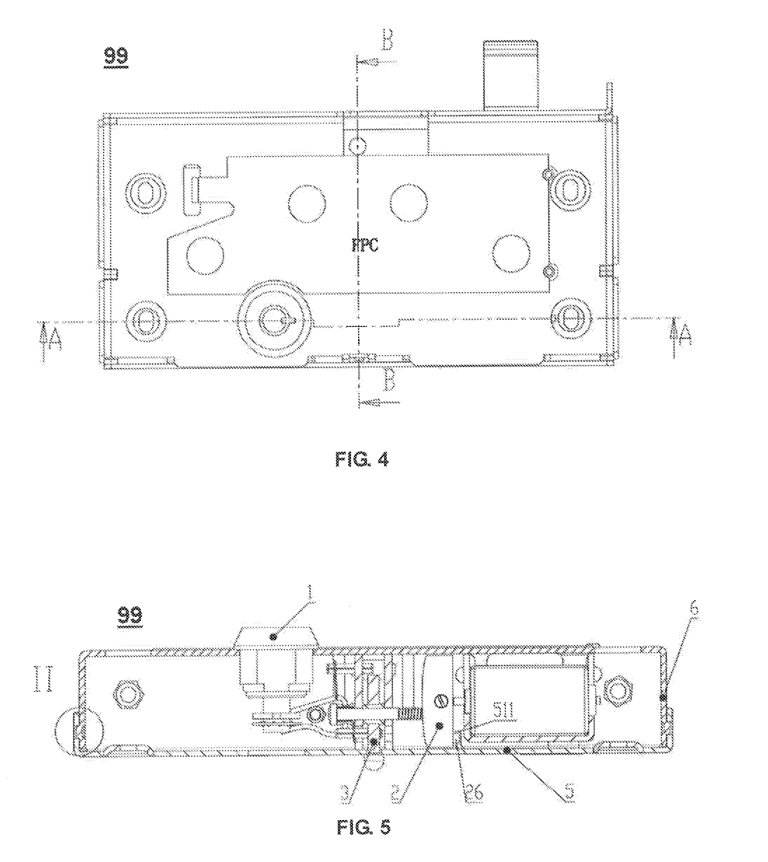

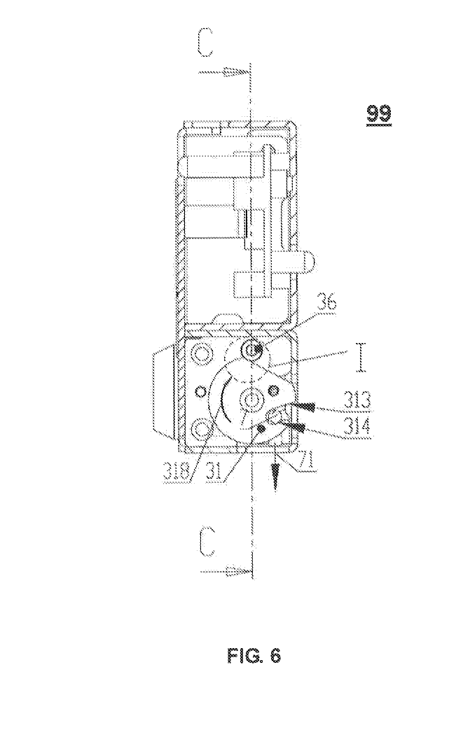

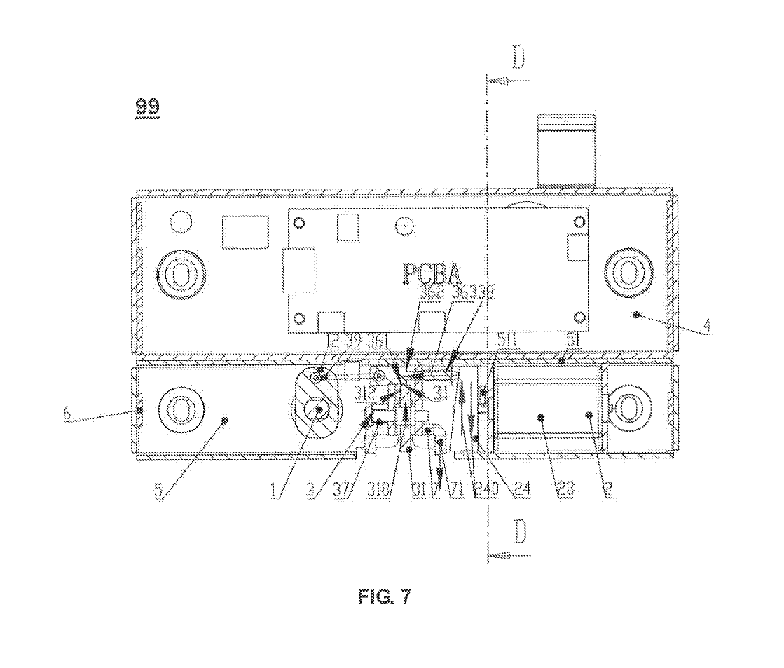

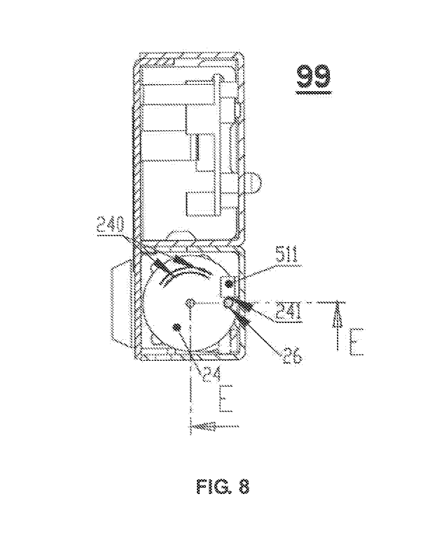

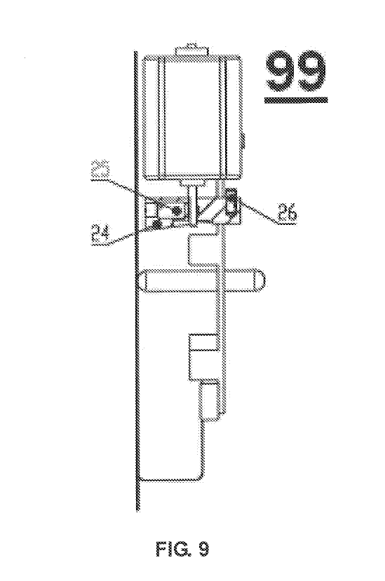

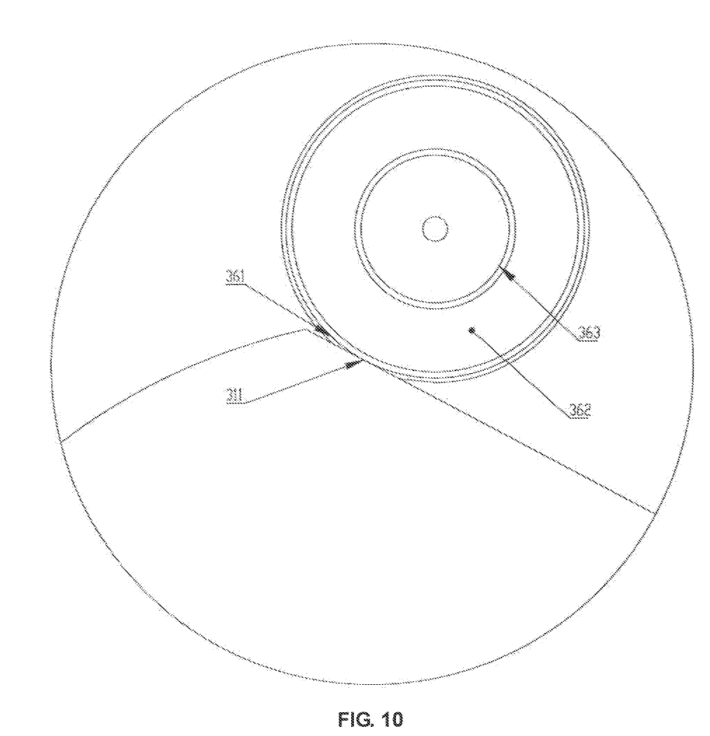

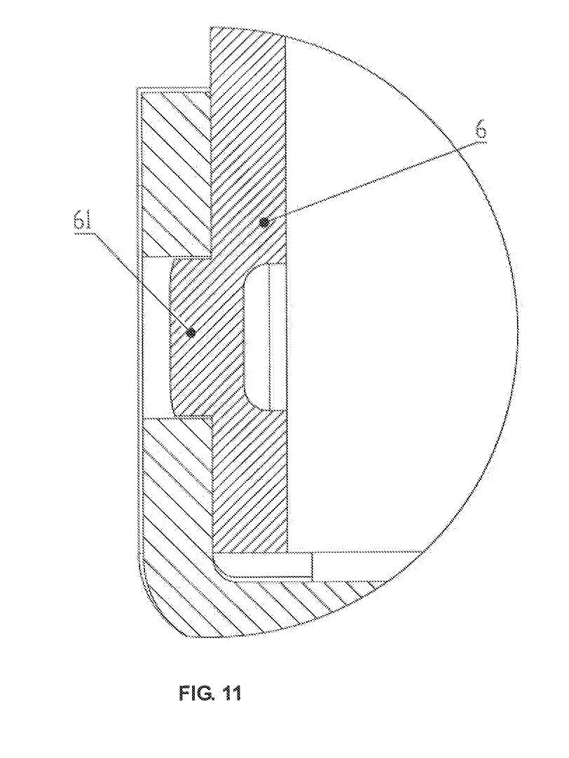

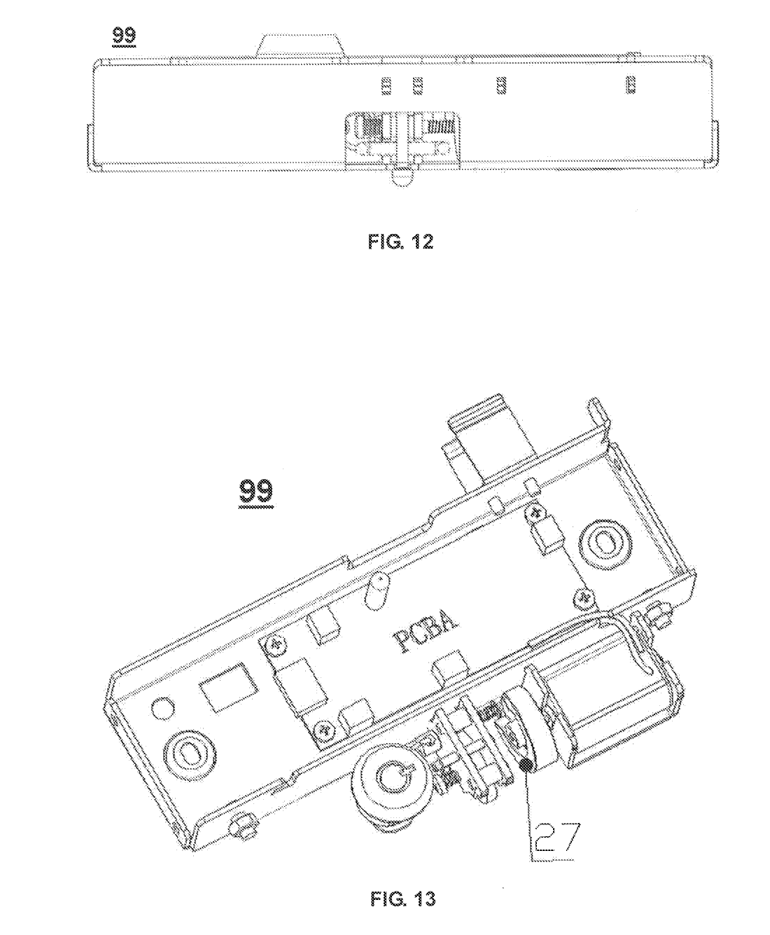

For FIG. 1-13, the marked elements are: 1, cam lock assembly; 11, cam Lock; 12, cam bolt; 13, toothed washers; 2, electronic control assembly; 21, PCB module; 22, membrane switch circuit; 23, electric motor; 24, drive disk; 25, Screws; 26, spring pin; 27, helicoidal disk; 3, latch bolt assembly; 31, latch bolt; 32, the second support sheet; 33, the first support sheet; 34, threaded sleeve; 35, double riveted column; 36, latch shaft; 37, torsion spring; 38, spring; 39, soft cord; 310, latch bolt mounting post; 311, the edge of latch bolt; 312, the left side of latch bolt; 313, the longer edge; 314 the shorter edge; 315, spring pin; 4, the electrical mounting assembly; 41, U-shaped bracket; 42, the battery snaps; 43, the mounting posts; 5, the mechanical mounting assembly; 51, U-shaped bracket; 52, the motor mounting bracket; 53, screws; 54, nuts; 55, riveted nuts; 6, lock plate; 61, the lock plate cum; 7, U-shaped block bar; and 99, electronic lock.

As shown in FIG. 1-12, the said invention includes the cam lock assembly 1, electronic control assembly 2, latch bolt assembly 3, whole housing assembly and u-shaped latch 7. The said whole housing assembly includes the lock mounting housing and the lock plate 6 joined to the lock mounting housing.

The said cam lock assembly 1, includes the cam lock 11, cam bolt 12 and toothed washers 13. The said cam bolt 12 is mounted in the cam lock 11 through the toothed washers 13.

The said lock mounting housing includes two parts. One part is used in mounting PCB module. For the convenience of description, here the mounting assembly part is called the electrical mounting assembly 4. The other part is mainly used in connecting the other components, such as the electric motor 23, lock assembly and latch bolt 3. For the convenience of description, here the mounting assembly part is called the mechanical mounting assembly 5. The said electrical mounting assembly 4, the mechanical mounting assembly 5, their main body are all set in a rectangular opening groove. The shorter side of the rectangular opening groove wall is shorter than the other, so that it is similar to a 41 U-shaped bracket or U-shaped bracket 51. The said electrical mounting assembly 4 and the mechanical mounting assembly 5 are arranged in a line. The longer side of the electrical mounting assembly 4 is connected to the longer side of the mechanical component by the screw thread, such as the bolt. The shorter side of the above two components are connected together.

For each different mounting component, the said electrical mounting assembly 4, on its bottom, includes the mounting posts 43, using for the position of the circuit board and also the battery snaps 42 on its bottom to provide the adequate battery for the circuit board. In the mechanical mounting assembly 5, because of the requirements for the mounting of components, for example, for the electric motor 23, in this mechanical mounting assembly 5 has two motor mounting brackets 52. Two ends of each motor mounting bracket are respectively fixed with two longer sides of mechanical component mounting assembly. Meanwhile, each motor mounting bracket 52 has a U-shaped slot, used to position bearing the electric motor 23. For the cam lock assembly, this invention sets the mounting hole in the mechanical component mounting assembly. For the latch bolt assembly 3, this invention sets the corresponding parts in the mechanical mounting assembly 5. Further, to fasten the electricity component mounting assembly firmly with the mechanical component, this invention sets the riveted posts to fix both.

Further, the said lock mounting housing has the lock plate 6, this plate is adapted to the lock mounting housing, to form a like closed rectangular space.

The said electric control assembly includes the circuit board, electric motor 23, drive disk 24 and spring pin 26. The circuit board includes the PCB module 21 and membrane switch circuit 22. The said PCB module 21 is located in the electricity mounting assembly 4. Membrane switch circuit 22 is embedded in the lock plate 6. The PCB module 21 and Membrane switch circuit 22 are opposite set. Furthermore, the circuit board is connected to the electric motor 23 work as the preset work environment. The output terminal of the said electric motor 23 connects to the drive disk 24, which has the through hole along the center. The output shaft of the electric motor 23 runs through the hole in the drive disk 24, which are tighten together by the cross recessed pan head screw. The drive side of said drive disk 24 is inclined side. The spring pin 26 is mounted on the opposite side of the inclined side of said drive disk 24. On the mounting assembly there is the limit block limited the rotation angle of said drive disk 24. In this invention, because the electric motor 23 is supported on the two U-shaped slots of said motor mounting bracket 52, the bracket supporting the output shaft of the electric motor 23 has a shoulder, when the spring pin 26 meets the shoulder, it stops the drive disk during the rotation of the inclined plate, to locate in the fixed place. Trough the electronic control assembly, clockwise, counter clockwise, driving one cycle to make the transmission plate reset its initial public position, in order to ensure and improve the reliability of locking, an available interstice is designed for the latch bolt 36. Furthermore, said drive disk can be designed to be a helicoidal cam disk. As shown in FIG. 13, Said helicoidal cam disk is identical to said drive cam disk, which also has a through hole along the center, where said output shaft of said electric motor 23 runs through. a drive surface of said helicoidal cam disk is a helicoidal surface.

The said latch bolt assembly 3, includes the latch bolt 31, latch bolt bracket, latch shaft 36. The said latch bolt bracket includes the support sheet, double riveted column 35. There are two said support sheets, namely first support sheet 33, second support sheet 32. The said first support sheet 33, second support sheet 34 are designed and arranged in parallel, fixed and tighten together by two double riveted columns 35. The said latch shaft 36 is a stepped shaft, including three portions of reduced in diameter orderly, namely the rough portion, middle portion and a fine long portion. The rough portion is the cam bolt mounting portion, has the cam bolt position mounting post. The fine long portion is the spring mounting portion mounted a spring collar in the end. The said fine long portion is placed through the first support sheet. The periphery of the fine long portion between the first support sheet and the spring stop connecting the reset and compression spring 38. Meanwhile, the end of the fine long portion is next to the inclined side of the drive disk. The rough portion is connected to the cam bolt through the soft cord 39. The step between the rough portion and the middle portion is used for limiting of the second support sheet 32. The middle portion is the latch bolt locking portion, where its cylinder is opposite to the edge of the latch bolt, the lock is in locked mode. When the middle portion staggers the edge of the latch bolt, namely where the middle portion separates from the edge of the latch bolt and the latch bolt works.

The said latch bolt is a disk. The mounting hole is designed on the center of the latch bolt. Said latch bolt is mounted on said latch bolt housing via said mounting hole. Meanwhile, said latch bolt includes two transmission portions. One is inclined plane connected said latch shaft 36 by the means of unlocking and locking, another is a block bar mounting portion which is slot and linkage connect to a U-shaped block bar 7. Meanwhile, the plate of the latch bolt mounting post 310. This latch bolt mounting post 310 is the screw and the latch bolt can pivot around the screw. The said screws is fixed and connected to the first support sheet 33 and the second support sheet 32 to the thread. The cross pan head of the screws is next to the second support sheet. The latch bolt is mounted between the first support sheet and the second support sheet 32. Meanwhile, the cross pan head of the screw joints the stud between the cross pan head of the screw and the second support sheet joints to the torsion spring 37 is snapped to the mounting post of the torsion spring on the mounting post of the torsion spring on the second support sheet. The other side is snapped to the mounting post of the torsion spring on the plate of the latch bolt.

Said latch is a U-shaped block bar 7. This U-shaped block bar 7 is a U-shaped rod-like component, including the horizontal portion and vertical portion with the same side connected to the vertical portion. The two ends of the vertical portion is connected to the door assembly (safe). The horizontal portion is respectively connected to the first support sheet and the second support sheet. The connection of the U-shaped block bar 7 with the first support sheet and the second support sheet is used to orientate its movement. The connection between the U-shaped block bar 7 and the latch bolt is to achieve the drive transmission of the U-shaped block bar from the latch bolt, namely the fixed connection between the U-shaped block bar 7 and the latch bolt. Meanwhile, the U-shaped block bar 7 is mounted in the edge of the latch bolt to push out and retract the latch bolt. The said edge in this invention is U-shaped edge. Its two sides are unequal. When in the unlocked mode, the longer edge side can cover the U-shaped block bar 7. When in the locked mode, the shorter edge can ensure the deep part of the two vertical portions of the U-shaped block bar is locked.

The Operational Principle of the Present Invention is:

The electric motor 23 rotates the drive disk 24 clockwise and counterclockwise, which makes the latch shaft 36 to move left, making the middle cylinder 361 of the latch shaft 36 slip off the latch bolt side face 311, having the latch bolt 31 deflect to a certain angle under the action of the torsion spring, and pushing out the U-shaped block bar, which is the unlock mode. The drive disk 24 is stopped and limited on the fixed position 241 by the shoulder 611 on the U-shaped bracket.

To unlock emergently, we should turn the bolt by emergent key 12, which pull the latch shaft 36 to move left by cord buckle 39, making the middle cylinder 361 of the latch shaft 36 slip off the latch bolt side face 311, having the latch bolt 31 deflect to a certain angle under the action of the torsion spring, and pushing out the U-shape block bar, that is the unlock emergency.

U-shape block bar 7 propel with the reverse direction of the arrow 71, pressing the latch bolt 31 rotated the opposite direction of the arrow 318, synchronously compressing the torsional spring 37. While the driving surface of the latch bolt 31 is off with the position between middle section of the latch shaft 36 and slender section 362, the latch shaft 36 move to the reverse way of the arrow 363 under the pressing spring 38, making the middle cylinder 361 of the latch shaft 36 blocked the latch bolt side 311, that is on lock.

We claim:

1. An electronic lock, the inventive electronic lock includes lock assembly, electronic control assembly, lock latch assembly and latch bolt assembly, wherein the said latch bolt assembly includes a pivotable latch bolt, latch bolt bracket and latch shaft, the said latch bolt is pivoted at the latch support, and the said latch shaft is translational positioned at it, wherein by the latch shaft, cam bolt and electronic control assembly can connect with latch bolt and latch component in sequence, wherein the said latch shaft is mounted a reset and compression spring, the said latch bolt is mounted a torsion spring and a latch mounting housing, then the said latch bolt is connected lock latch assembly via said latch mounting housing.

2. The present invention of claim 1, wherein said latch bolt bracket includes two support sheets designed and arranged in parallel, namely the first support sheet, the second support sheet, wherein said support sheets are connected by fasteners, wherein in addition, a latch bolt mounting post (screw bolt) is designed to support the latch bolt mounted between the said two support sheets, wherein the said torsion spring is mounted around said latch bolt mounting post.

3. The present invention of claim 2, wherein said latch shaft is a stepped shaft, including the cam bolt mounting portion, the latch bolt locking portion and spring mounting portion, wherein the diameter of said latch bolt locking portion is bigger than the one of the spring mounting portion, wherein the said cam bolt mounting portion is connected to the cam bolt via a soft string, wherein the end of the spring mounting portion is withstood by the power output inclined plane or spiral surface of said lock electronic control assembly, wherein said spring mounting portion is designed through the first support sheet, wherein said latch bolt locking portion is on the left of the second support sheet, wherein a spring collar is mounted nearly to the end of the spring mounting portion, wherein the two ends of said compression spring is mounted between said first support sheet and said spring collar.

4. The present invention of claim 1, wherein said latch bolt is a disk, wherein the mounting hole is designed on the center of the latch bolt, wherein said latch bolt is mounted on said latch bolt housing via said mounting hole, wherein meanwhile, said latch bolt includes two transmission portions, wherein one is inclined plane connected said latch shaft by the means of unlocking and locking, another is a block bar mounting portion which is slot and linkage connect to a block bar assembly, wherein in addition, a torsion spring mounting post is designed on the plate of said latch bolt, and which is fastened with an end of the torsion spring.

5. The present invention of claim 4, wherein said block bar assembly includes U-shaped block bar, wherein said U-shaped block bar is a U-shaped rod element, including one horizontal portion and two vertical legs in the same direction, wherein said horizontal portion is fixed with said slot of said latch bolt.

6. The present invention of claim 2, wherein said latch bolt is a disk, wherein the mounting hole is designed on the center of the latch bolt, wherein said latch bolt is mounted on said latch bolt housing via said mounting hole, wherein meanwhile, said latch bolt includes two transmission portions, wherein one is inclined plane connected said latch shaft by the means of unlocking and locking, another is a block bar mounting portion which is slot and linkage connect to a block bar assembly, wherein in addition, a torsion spring mounting post is designed on the plate of said latch bolt, and which is fastened with an end of the torsion spring.

7. The present invention of claim 6, wherein said block bar assembly includes U-shaped block bar, wherein said U-shaped block bar is a U-shaped rod element, including one horizontal portion and two vertical legs in the same direction, wherein said horizontal portion is fixed with said slot of said latch bolt.

8. The present invention of claim 1, wherein said electronic control assembly includes a motor housing, a drive electric motor which is mounted on said mounting housing and a drive disk which is mounted on an output terminal of said drive motor, wherein said drive disk is designed to bean inclined cam disk, or a helicoidal cam disk, wherein an inclined plane of said drive disk or a helicoidal surface of said helicoidal disk is withstood by said latch shaft, wherein a limiting mechanism is designed between said inclined cam disk or said helicoidal cam disk and said motor housing.

9. The present invention of claim 8, wherein said limiting mechanism includes a dowel pin and a limiting block leg, wherein said spring pin is mounted on said inclined cam disk, wherein said limiting block leg is a shoulder on the electric motor housing.

10. The present invention of claim 9, wherein said electric motor housing includes two portions of bending edges designed and arranged in parallel, which includes two U-shaped slots, wherein said electric motor is fixed and hanged by said U-shaped slots.

11. The present invention of claim 2, wherein said electronic control assembly includes a motor housing, a drive electric motor which is mounted on said mounting housing and a drive disk which is mounted on an output terminal of said drive motor, wherein said drive disk is designed to bean inclined cam disk, or a helicoidal cam disk, wherein an inclined plane of said drive disk or a helicoidal surface of said helicoidal disk is withstood by said latch shaft, wherein a limiting mechanism is designed between said inclined cam disk or said helicoidal cam disk and said motor housing.

12. The present invention of claim 11, wherein said limiting mechanism includes a dowel pin and a limiting block leg, wherein said spring pin is mounted on said inclined cam disk, wherein said limiting block leg is a shoulder on the electric motor housing.

13. The present invention of claim 12, wherein said electric motor housing includes two portions of bending edges designed and arranged in parallel, which includes two U-shaped slots, wherein said electric motor is fixed and hanged by said U-shaped slots.

14. The present invention of claim 1, wherein said cam lock assembly, said electric control assembly, said latch assembly and said latch bolt assembly are all mounted and concealed inside a whole housing assembly, wherein said whole housing assembly includes a lock mounting housing and a lock plate connected to the lock mounting housing.

15. The present invention of claim 14, wherein said whole housing assembly includes an electrical mounting assembly and a mechanical mounting assembly, wherein a PCB module of said electronic control assembly is mounted in said electrical mounting assembly, wherein said electric motor, said drive disk and said cam lock assembly, said latch bolt assembly and said latch bolt assembly are mounted in the mechanical mounting assembly, wherein said electrical mounting assembly and said mechanical mounting assembly may be connected together via screws and nuts.
